(19) United States
(12) Patent Application Publication
(10) Pub. No.: US 2010/0167766 A1
(43) Pub. Date: Jul. 1, 2010

(54) INTEGRATED MIXED TRANSPORT MESSAGING SYSTEM

(76) Inventors: Matias Duarte, Sunnyvale, CA (US); Justin Kodama, East Palo Alto, CA (US); Amir Haghighat, Cupertino, CA (US); Manisha Parekh, Mountain View, CA (US); Michael Rizkalla, Los Altos, CA (US)

Correspondence Address: MAHAMEDI PARADICE KREISMAN LLP, 550 Winchester Boulevard, Suite 605, SAN JOSE, CA, 95128, US

(21) Appl. No.: 12/347,827

(22) Filed: Dec. 31, 2008

(51) Int. Cl. H04W 4/12

(52) U.S. Cl. 455/466

(57) ABSTRACT

A computing device operates a plurality of messaging programs that use different messaging transports. The computing device includes processing resources that operate to provide a messaging database that interfaces with the plurality of messaging programs to record instances of incoming or outgoing messages using anyone of the plurality of messaging programs. The processing resources execute in connection with maintaining the messaging database in order to associate individual incoming messages or outgoing messages with either a new messaging thread or an existing messaging thread. The incoming messages and outgoing messages of each new or existing messaging thread being received or sent through any one of the plurality of messaging programs, so that the messaging threads can be mixed in the type of messages that are provided.

### TECHNICAL FIELD

The disclosed embodiments relate to mobile computing devices. More particularly, the disclosed embodiments relate to a messaging system for a mobile computing device.

### BACKGROUND

Computing devices, particularly handheld and portable devices, have evolved to include numerous types of communication capabilities and functionality. For example, handheld devices exist that operate as cellular phones, messaging terminals, Internet devices, while including personal information management (PIM) software and photo-management applications. Additionally, Internet Protocol services exist that can transform Internet-enabled machines into telephony devices. Even stand-alone telephones that connect to traditional Public Switched Telephone Networks (PSTN) are including more software to enhance the telephone's functionality.

In enhancing communication capabilities and functionality, effort has been made to enhance and assist the user in using such devices. For example, software features exist to facilitate the ease in which the user can act on a phone number in an email message. A sequence of phone numbers can be presented to a user for selection, and upon such selection being made, a telephony application uses the phone number in making a phone call. Small form-factor computing devices, such as devices that provide cellular phone functionality, have particular use for such short-cut functionality, in order to reduce the manual involvement of the user. These devices have smaller keyboards that may be harder to operate, and/or use in mobile or dynamic environments, where the user cannot readily retrieve a desired number.

Telephony devices are just one type of communication device. There are now many types of communication types, and multi-functional devices exist to accommodate the different communication types. Examples of communication types other than telephony include email, instant message (including SMS protocol messages and Multimedia Message Service (MMS) protocol messages), Internet based Instant Messaging, and video conferencing. Many computing devices, particularly smart phones, are enabled to support communications using multiple communication mediums.

### BRIEF DESCRIPTION OF THE DRAWINGS

FIG. 1 illustrates an architecture for implementing a messaging system for enabling mixed transport message threading on a computing device, according to an embodiment.

FIG. 2 illustrates a computer-implemented method for implementing mixed transport message threading on a computing device, under an embodiment.

FIG. 3 illustrates a computer-implemented method for automatically selecting an appropriate messaging transport for exchanging communications with another person based on the online status of the other person, under an embodiment.

FIG. 4 illustrates a method for maintaining a buddy list for use in messaging with multiple transports, under an embodiment.

FIG. 5A is a sample user interface panel on which a plurality of mixed transport message threads are provided as entries, under an embodiment.

FIG. 5B is a sample user interface panel that displays a message thread in open form, according to an embodiment.

FIG. 5C is a sample user interface panel that illustrates a mixed transport thread that includes messages exchanged using three messaging transports, according to an embodiment.

FIG. 5D is a sample user interface panel that displays a buddy list that may be used on a messaging system such as described by any of the embodiments provided herein.

FIG. 6 illustrates a hardware diagram for a mobile computing device configured in accordance with one or more embodiments of the invention

### DETAILED DESCRIPTION

Embodiments described herein provide for a messaging system on a computing device that enables the use of mixed transport messaging threads. A mixed transport messaging thread refers to a cluster or list of messages that are exchanged between a user and another party, where the messages included in the thread are communicated using different types of messaging transports. The clustering may take the appearance of chat or conversation, or be provided in list form. Optionally, the mixed transport messaging thread includes other functionality, such as enabling the user to send a message to an individual in the thread by replying to an existing message.

Still further, an embodiment provides that a messaging system includes a messaging database that operates with other resources to enhance the user's messaging experience. Among other features, one or more embodiments provide a messaging database that enables individual messages, communicated on the computing device using any one of multiple possible transports, to be associated with information from sources such as a contact data store and/or information available from an Instant Messaging service. A contact data store may be used to enable contact-centric viewing of messages. For example, messages communicated to or from a common contact of the user through different messaging transports (and messaging identifiers) may be displayed by a contact name and/or picture.

Still further, embodiments enable use of a messaging database to enhance presentation of a buddy list. Among other features, the messaging database may be used to combine buddy lists from two or more Instant Messaging services, augment buddy lists with information recorded on the computing device, or enhance buddy lists by filtering entries that are duplicate as to the contact (but not the messaging identifier).

In an embodiment, a computing device operates a plurality of messaging programs that use different messaging transports. The computing device includes processing resources that operate to provide a messaging database that interfaces with the plurality of messaging programs to record instances of incoming or outgoing messages using anyone of the plurality of messaging programs. The processing resources execute in connection with maintaining the messaging database in order to associate individual incoming messages or outgoing messages with either a new messaging thread or an existing messaging thread. The incoming messages and outgoing messages of each new or existing messaging thread being received or sent through any one of the plurality of messaging programs, so that the messaging threads can be mixed in the type of messages that are provided.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

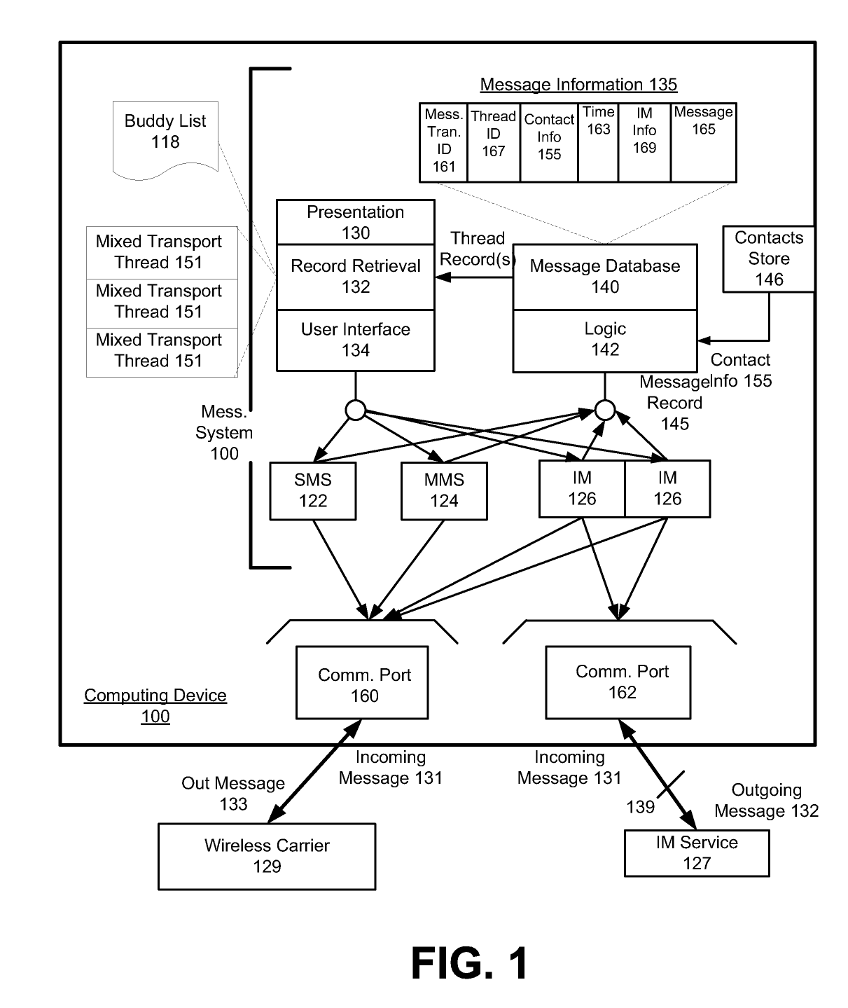

FIG. 1 illustrates an architecture for enabling a unified, contact-centric messaging system that integrates multiple kinds of messaging transports in accordance with embodiments described herein. In an embodiment, a messaging system 110 is implemented on a computing device 100 in order to enable mixed transport messaging threads. Such mixed transport messaging threads enable a user of the computing device 100 to carry on a ‘conversation’ with another person using any one or many different transports that the two persons can use to exchange messages.

As an addition or alternative, the messaging system 110 provides a unified presentation for different kinds of messaging transports. From the unified presentation, functionality such as buddy lists and message listing, contact record information, and online status information may be integrated for use with the different messaging transports.

According to one or more embodiments, the computing device 100 corresponds to a mobile and/or multi-functional devices having messaging capabilities across either voice or data channels. An example of such computing devices is a cellular telephony/messaging device. Such devices often are often equipped with ancillary functionality, such as image/video capture, media playback, and Global Positioning System enables (e.g. for navigation).

In more detail, computing device 100 includes one or more communication ports 160, 162 to enable communications to be sent and received on the device using different kinds of communication mediums (including different kinds of wireless communication mediums). Each communication port 160, 162 includes hardware and associated logic (which may be implemented through hardware, firmware or software) to enable data to be sent and received using a particular transmission medium or off-device resource. In one embodiment, communication ports 160, 162 enable wireless communications and use separate hardware components. For example, each communication port may include or use a chipset and logic to send and receive data using a particular wireless communication medium. As examples, each of the communication ports 160, 162 may enable wireless communications in the form of one of (i) cellular transmissions (e.g. GSM, CDMA, Edge, 3G), (ii) Wireless Fidelity (i.e. “WiFi” or 802.11(b), (g) or 802.11(n)), (iii) Worldwide Interoperability for Microwave Access (WiMAX), (iv) or local wireless communication such as wireless USB or Bluetooth. Computing device may include logic/hardware interfaces to enable individual messaging applications to use one or more of the communication ports 160, 162. For simplicity, first wireless communication 160 is assumed to support cellular type communications (3G, GSM, CDMA etc.) for both voice and data, while second communication port 162 is assumed to support WiFi.

With further reference to FIG. 1, messaging system 100 includes a plurality of messaging programs, depicted in an embodiment of FIG. 1 as an SMS program 122, an MMS program 124, and one or more IM programs 126. Additional or alternative kinds of messaging programs, such as an email program (POP3 or SMTP), may be also be used with an embodiment such as shown. The message system 110 may include a message database 140, with associated database logic 142, and a presentation component 130. The presentation component 130 may include or operate with a record retrieval component 132 that interfaces or is an extension or element of the database logic 142. The presentation component 130 also includes a user interface 134 that displays output from the messaging system 110, as well as enabling receipt of input and user interaction. As described further, the user interface 134 displays mixed transport messaging threads 131, as well as buddy lists 118 and other messaging related information.

Each messaging program 122-126 is configured to send and receive messages from the computing device using a particular kind of messaging protocol (including messaging format). Additionally, the programs 122-126 may control or initiate performance of operations by the device or network resources to support the device in using a particular transport. In the case of IM program 126, the program may seek a corresponding network side server or service 127, with which the program opens a communication socket over a network that includes the Internet 139. The communication socket is then used to transmit instant messages, while at the same time enables the computing device to receive ‘push’ initiated incoming messages from other computers and devices. Instant Messaging service 127 also communicates other information, such as (i) a buddy list for that service, (ii) online status information for individual buddies or contacts of the user as known by the service, and (iii) moniker information, such as a picture of a buddy. The SMS and MMS programs 122, 124 communicate with resources of a wireless carrier 129 or network. In an implementation for computing device 100, the SMS program 122 and MMS program 124 are only capable of using the first (cellular) communication port 160 (to communicate with resources of carrier 129), while the IM program 126 is able to use either communication port, provided that the device is able to achieve an Internet connection. In another implementation, each program is able to more than one communication, but is assigned by default to one of the communication ports that is preferred for the particular kind of messaging transport.

The user interface 134 of the presentation component 130 displays records of messages exchanged between the device user and another person using any one or all of the messaging programs 122-126. As will be described, one or more embodiments are configured to associate records of messages exchanged between the user and another participant as part of a single thread 151. Within the single thread, the user interface 134 displays records of messages between the device user and the other participant, even when the messages are communicated using different messaging transports, such as provided by the IM application 126 and the SMS or MMS application 122, 124.

When the computing device 100 sends or receives messages through one of the messaging applications 122-126, the message database 140 records or stores an instance of the message. With regard to outgoing messages, an embodiment provides that the user interface 134 serves as an interface for each of the messaging programs 122-126. Outgoing messages 131 may be composed through the user interface 134. When the user composes and sends a message, the messaging program in use records an instance of the message in the message database 140. As an alternative, outgoing messages 130 may be composed and recorded in the database 140 by the presentation component 130. The messaging applications 122-126 then retrieve the messages from the database 140 and transmit the messages through the selected or appropriate communication port 140, 142. Incoming messages 133, on the other hand, are received by the application of the transport and then transferred to the message database 140. Each recorded instance of an outgoing or incoming message 131, 133 is parsed by the database logic 142. According to an embodiment, the messages may be parsed and analyzed in order to identify and store message information 135. The message information 135 may be stored as a database or relation record, and include information corresponding to: (i) the message transport identifier 161 of sender and/or recipient, (ii) a time 163 that the message being sent/received, or (iii) the message body 165. Other information may also be identified and stored in the parsing and analysis, such as attachments, and/or media files or content (e.g. voice data that may accompany the message). In one embodiment, a thread identifier 167 may also be associated with the message information 135. In instances when the instance of the message is outgoing, the thread 151 from which the message was composed may be identified and recorded. If the message was composed outside of a thread, either the message is recorded to have a new thread identifier, or the thread associated with the recipient of the message is used as the thread identifier. In instances when the message is incoming, the thread identifier may be identified from analysis of the message information, such as by identification of the sender (i.e. the message transport identifier of the sender) of the message. The message information 135 may also record other kinds of information, such as the message type. The message information 135 may be stored as, for example, a table or other relational data structure.

The presentation component 130 uses the message information 135 to present the individual incoming/outgoing message in an appropriate messaging thread 151151. In an embodiment, each messaging thread 151151 is between the user of the device 100 and at least one other person. As stated, the contents of the conversation thread include records of instances of messages communicated through any of the transports used by the messaging programs 122-126.

In an embodiment, a contact store 146 is used to integrate contact record information 155 with information stored in the message store. Among other uses, the contact record information 155 may be used to provide identifying content with individual conversation threads. For example, each conversation thread 151 may be displayed by the name of the other participant as provided by a contact record that is on or known by the device 100. When a new thread is created, for example, the message identifier of the other participant (the “to” field for outgoing messages and the “from” field for incoming messages) may be cross-referenced by the database logic 142 against the contact store 146 to identify a matching contact. The contact information 151 may be retrieved for a given message identifier and then stored in the data store 124 in association with the message identifier. The contact information 151 may correspond to identifying information, such as the name of the person of the matching contact record. As an alternative or addition, an image stored with the contact record may also be provided with the contact information 151. In an embodiment, the presentation component 130 displays at least some of the contact record information 155 as part of the conversation thread 151

In an embodiment, use of the contact store 146 makes uniform the manner in which records or instances of a message are displayed using one of the programs 122-126. The messaging programs 122-126 inherently are associated with more identifiers than just a person's name. For example, a given person may use more than one cellular phone, and thus may have more than one identifier (e.g. cellular phone number) associated with them for SMS or MMS messaging. In instant messaging, individuals often have monikers that may or may not be anonymous. With each instance of a new message (whether incoming or outgoing), the database logic 142 may make a determination as to whether the identifier 161 for the other party of the message is known or otherwise associated with a contact record in the contact store 146.

| Message | | | | Contact of | Thread | Message |
|---|---|---|---|---|---|---|
| ID | Sender | Recipient | Type | (Other) | ID | Body |
| 1 | user | 6505554545 | SMS | Joe Smith | 1 | “What |
| | | | | (Recipient) | | time . . . |
| 2 | 6505554545 | User | SMS | Joe Smith | 1 | “Tell |
| | | | | (Sender) | | you |
| | | | | | | when I |
| | | | | | | am |
| | | | | | | home . . . ” |
| 3 | Crazykidz2@gtalk | User | IM | Joe Smith | 1 | “8pm” |
| 4 | User | Crazykidz2@gtalk | IM | Joe Smith | 1 | “thx” |

Table-1 is a simplified representation of a mixed transport messaging thread, as represented by corresponding set of database records, under an embodiment. The set of records displayed in Table-1 represent the exchange of messages between a user of the computing device 100, and another participant in the ‘conversation’. A message thread generally has the characteristic of presenting messages between participants of a messaging conversation in a cluster or list. For example, on the computing device 100, a user may scroll or scan a display area to view one message after another in the thread, as the messages are lumped or sorted together. Moreover, in many implementations, a participant of the messaging conversation can simply reply to another message in the thread, rather than compose a new message.

With regard to the example provided by Table 1, conversation thread 151 is exchanged between the device user and the individual identified by the contact records as “Joe Smith”. The contact record for Joe Smith may include SMS or cell/mobile identifier as “6505554545”, and instant messenger identifier Crazykidz2@gtalk. In one embodiment, the thread 151 for the conversation (or exchange of messages) depicted in Table-1 uses the contact record identifier (“Joe Smith”) as its identifying information. A picture associated with the contact record for Joe Smith may also be used. The picture may be provided as part of the contact information 155, or provided from other sources (e.g. Instant Messaging Service 127). As further depicted by the example of Table 1, an embodiment such as described enables the user of the device to present messages from another person (Joe Smith) in one thread even when the messages uses different transports (SMS and IM), and/or communicated over different communication ports 160, 162 of the computing device 100. Moreover, the fact that messages from the other party (i.e. Joe Smith) have different message identifiers for that person does not preclude those messages from being identified in the same conversation thread 151 (i.e. conversation thread for Joe Smith), provided the message identifiers are known or associated with the contact record of the other party (e.g. “Joe Smith”).

In an embodiment depicted by Table-1, a record 145 of a message is placed in the thread each time the user sends a message to the other participant (“Joe Smith”), or receives a message from that person. Following the original message of the thread, the next message may be either a “reply message” or a newly composed message that is automatically associated with the thread on the computing device.

The presentation component 120 may list the conversation threads 151 as a list. Optionally, the threads 151 are sequenced historically, such as in order of displaying the most recently used thread first. Additionally, according to an embodiment, the presentation component 130 displays other lists and information using information stored in the message database 140. One list that can be provided by the presentation component 130 is the buddy list 118. In one implementation, the buddy list 118 corresponds to a list of individuals that the user of the device either frequently or recently has exchanged messages with. As an alternative or addition, the buddy list 118 corresponds to a buddy list provided by one or more Instant Messaging services. For example, the buddy list 118 may correspond to a list provided by an Instant Messaging service, or a combined list from multiple sources (e.g. from multiple Instant Messaging services 127, or from messaging service and recently messaged list). Thus, the buddy list 118 may be provided (at least in part) from the Instant Messaging service 127. The database 140 may store information 169 that is derived from the Instant Messaging service 127. The Instant Messaging information 169 may include buddy list identifiers, buddy list moniker information (e.g. pictures or monikers of the user's buddy list), and online status information (as to whether the buddy's are logged on to the Instant Messaging service 127). The buddy list as provided on the computing device, provides a quick or easy way for the user to compose a new message. In one implementation, the new message may be associated with an existing thread for that buddy. However, not all composed messages need to be associated with a thread.

In an embodiment, the message database 140 maintains the information for enabling the presentation component 130 to display the buddy list 118. Information used to create or present the buddy list on the computing device (apart from information provided from the Instant Messaging Service 127) includes (i) contact record information 155 for the person in the buddy list, if that information exists, (ii) identifiers 167 to existing threads for that buddy, and (iii) optional or default setting as to the transport/program that is to be used for newly composed messages to that person. Timing information 163, such as the time of the last communicated message, may also be used to enable the buddy list to be sorted by a mechanism such as “most recently messaged”. The online status of each buddy that has an IM identifier may also be maintained by the Instant Messaging Service 127, which receives the information from the corresponding service. Thus, a given buddy list may display a list of buddies, with at least some buddies being identified by the contact record information for the person. The buddy list 118 may be sorted by one or more parameters, such as by buddy group, by online status, and/or by alphabet. The buddy list 118 may also be sorted by time and include online status information for individual persons. In one implementation, time, buddy group, online status and name/alphabet are all used to perform the sort of the buddy list (or other list).

Methodology

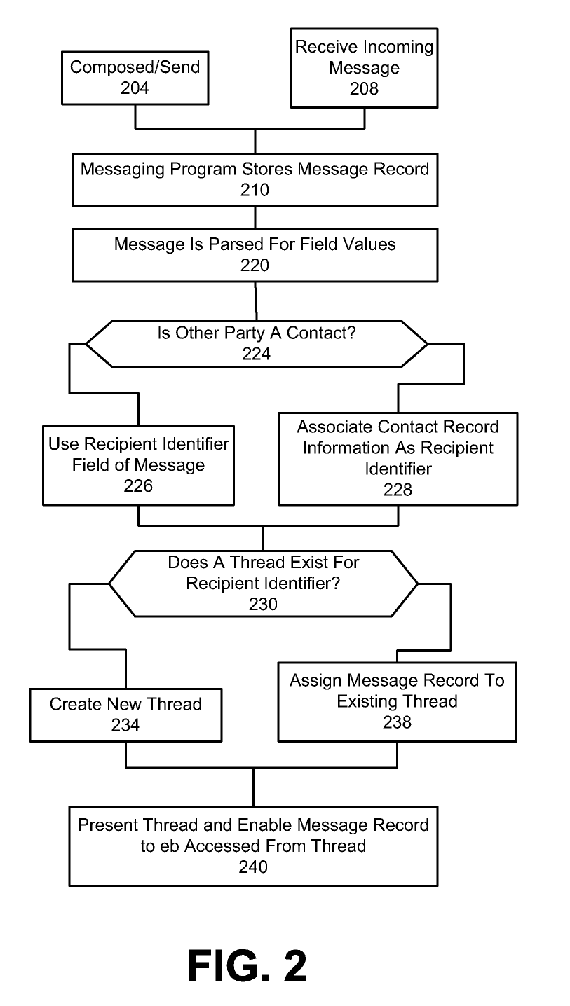

FIG. 2 through FIG. 4 illustrate different methods by which a messaging system may be implemented to integrate the operability of different messaging transports, according to one or more embodiments. In describing embodiments of FIG. 2 through FIG. 4, reference may be made to a computing device and/or messaging system such as described with FIG. 1. Accordingly, reference may be made to an embodiment of FIG. 1 for purpose of illustrating suitable elements or components for implementing a step or sub-step being described.

FIG. 2 illustrates a computer-implemented method for implementing mixed transport message threading on a computing device, according to an embodiment. In particular, a method such as described may be used to enable a user of computing device 100 to establish a messaging thread with another participant of a series of message, where the messaging thread utilizes different messaging transports and/or communication ports. In one embodiment, the mixed transport messaging thread incorporates messages that use Instant Messaging (as provided over Internet-based messaging services such as AIM or MICROSOFT MESSENGER) in connection with one or more services that are traditionally supported by cellular voice services: SMS or MMS. In the context of a cellular mobile computing device, the data channel for enabling Instant Messaging transport may use either cellular or other wireless (or even wireline) communication port, while SMS or MMS or enables through the voice channel of a cellular service.

A method such as described may be initiated in response to a messaging event. A messaging event may correspond to either (i) the user of the computing device sending an outgoing message (204), or (ii) the computing device receiving an incoming message (208) for the user. In step 204, the outgoing message may be either a reply message or a newly composed message (i.e. one that the user composes by inserting the value of the address field). As mentioned above, a method such as described may be implemented on a computing device that uses wireless voice/data communications. Accordingly, each of the incoming or outgoing messages may be provided in the form of a wireless communication, such as by way of a cellular transmission.

Each of the messages that correspond to a messaging event may be made through any one of multiple possible messaging transports. In an embodiment, immediate messaging transports such as SMS, MMS and Instant Messaging (by anyone or more third-party providers, such as AIM as provided by AMERICA ONLINE, MSN MESSENGER as provided by MICROSOFT CORP., and GTALK provided by GOOGLE INC)are integrated in a manner described, although other messaging transports such as email may be included.

In step 210, a record of the message is stored. In an embodiment, the program that is used to send or receive the message of the event stores a record of the message in the database 140.

Step 220 provides that the message is parsed for its fields and related information. In an embodiment, database logic 142 parses the message to identify information that includes the message transport identifiers of the other participant of the message exchange. For incoming messages, the value of the “from” field may identify the other participant. Likewise, for outgoing messages, the value of the “to” field identifies the other participant. The message transport identifier may correspond to, for example, a cellular phone number (for SMS, MMS) or a moniker (for Instant Messaging). Other information that may be parsed from the message and stored as part of the record includes the body of the message, as well as the time the message was sent or received.

In an embodiment, step 224 provides that a determination is made as to whether the message transport identifier of the other participant is listed or otherwise associated with a contact record. The determination may be made in order to list or display contact record information 155 with the record of the message, for use when the record is displayed as part of a given messaging thread. In this way, the use of contact record information enables the message to be displayed in a contact-centric manner, such as by a person's name or picture. Additionally, use of the contact record enables messages exchanged with the individual of the contact record using different transports to share a common association with the contact record. This allows messages exchanged with a person of the contact record to be threaded (i.e. associated with a cluster of messages between same sender and recipient), even when different transports are used, as depicted by Table-1. Additionally, other messaging features (such as lists of messages recently sent) may depict the messaging event by the name of the contact record, rather than by information identified in the to/from field of the message.

Accordingly, the database logic 142 may compare the identified transport identifier of the other participant (i.e. the non-user in the exchange) to individual fields in the contact records 146 stored on the computing device in order to determine whether the messaging identifier of the other participant is listed in the contact records. If the determination of step 224 is that no contact record exists that incorporates the message identifier of the messaging event, then step 226 provides that the transport message identifier of the party in the record message (e.g. the “From” field for an incoming message) is kept for use in identifying the other party on the computing device in the context of a thread or buddy list.

If, however, the contact record does exist which incorporates the identified messaging identifier, then step 228 provides that identifying information from that contact record is associated with the message identifier of the other party in the recorded message event.

As an example, a number listed as the message identifier for the SMS or MMS transport may be compared against phone number fields of the contact records in order to determine a contact record. The step may be performed by the database logic 142, or other programming, using message information 135. If the contact record exists, the record of the SMS message is associated with the name of the person who is under the identified contact record. In this way, step 224 and 228 may be performed as part of a general effort to associate messages with persons, rather than as message identifiers, which in many cases can be non-descriptive of individuals. For example, the SMS messaging transport uses cellular phone numbers, and Instant Messaging allows for monikers that are not necessarily descriptive of a person's name.

Once an identifier is established for the other party in the message event, a determination is made in step 230 as to whether a thread exists for that party. In the case where no contact record was identified for the recorded message, the transport identifier 161 of the recorded message may be used to determine whether another thread exists that is between the user and the same transport identifier. If however, the contact record is identified as described in step 228, then an embodiment provides that a determination is made as to whether another thread exists for the contact record.

As an addition or alternative, information other than the contact record may be used to associate a message record with an existing thread. In each implementation, each message record may be analyzed for clues to determine whether the message can be associated with an existing thread. For example, semantic or phonetically equivalent messaging identifiers may be programmatically determined to be likely from the same person. As a specific example, message identifiers that comprise “John.Smith”, “JSmith” and “JohnSmith” may be programmatically determined to be associated with the same person.

If no thread exists for a message record, then step 234 provides that a new thread is created for the message record. For the case when the transport identifier has no contact record, the new thread may use the transport identifier as a primary identifier. For the case where the message identifier of the recorded message has a contact record, information form the contact record (such as first and last name, picture) may be used as identifying information for the new thread.

If there is an existing thread, the step 238 provides that the recorded message is assigned to the existing thread. The database logic 142 may, for example, associate the message record with the existing thread identifier 167 of the existing thread. Since one contact record may include identifiers for different kinds of messaging transports, the pairing of the recorded message to an existing thread is not necessarily limited to the thread having messages that use another transport identifier for the same contact record. The newly recorded message may be made part of that thread, so as to create the mixed thread transport.

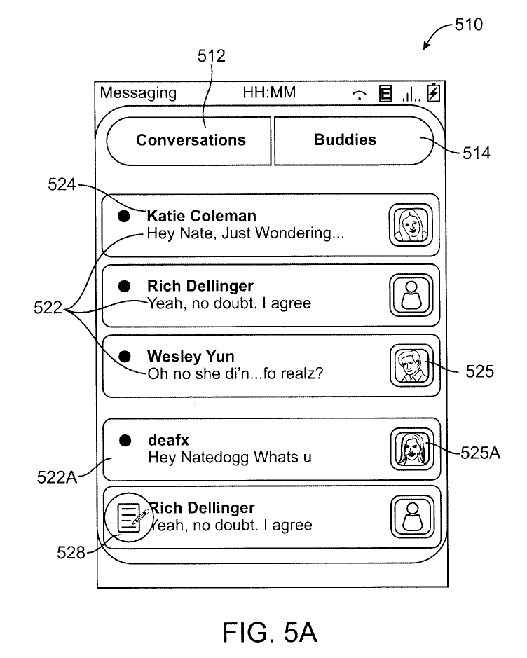

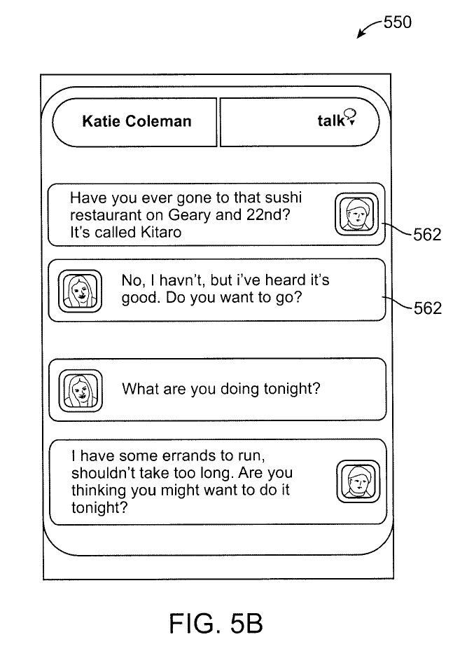

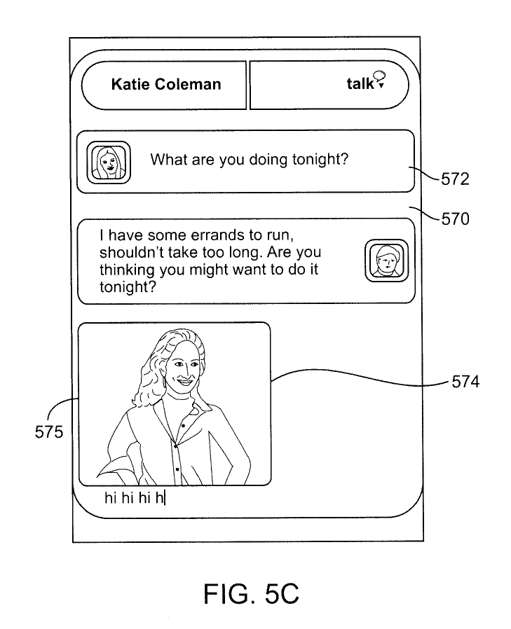

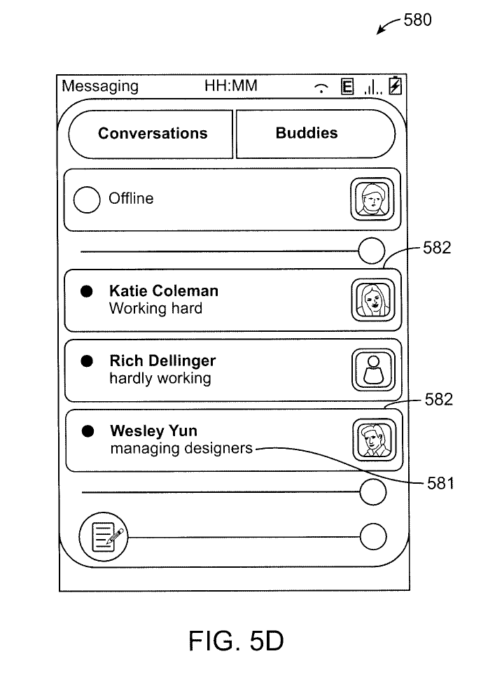

In step 240, the thread may be presented to the user. Examples of threads as displayed on a computing device are depicted with embodiments of FIG. 5A through FIG. 5D. From the thread, individual messages that comprise the thread may be viewed, opened, and replied to, even when messages are communicated across multiple transports.

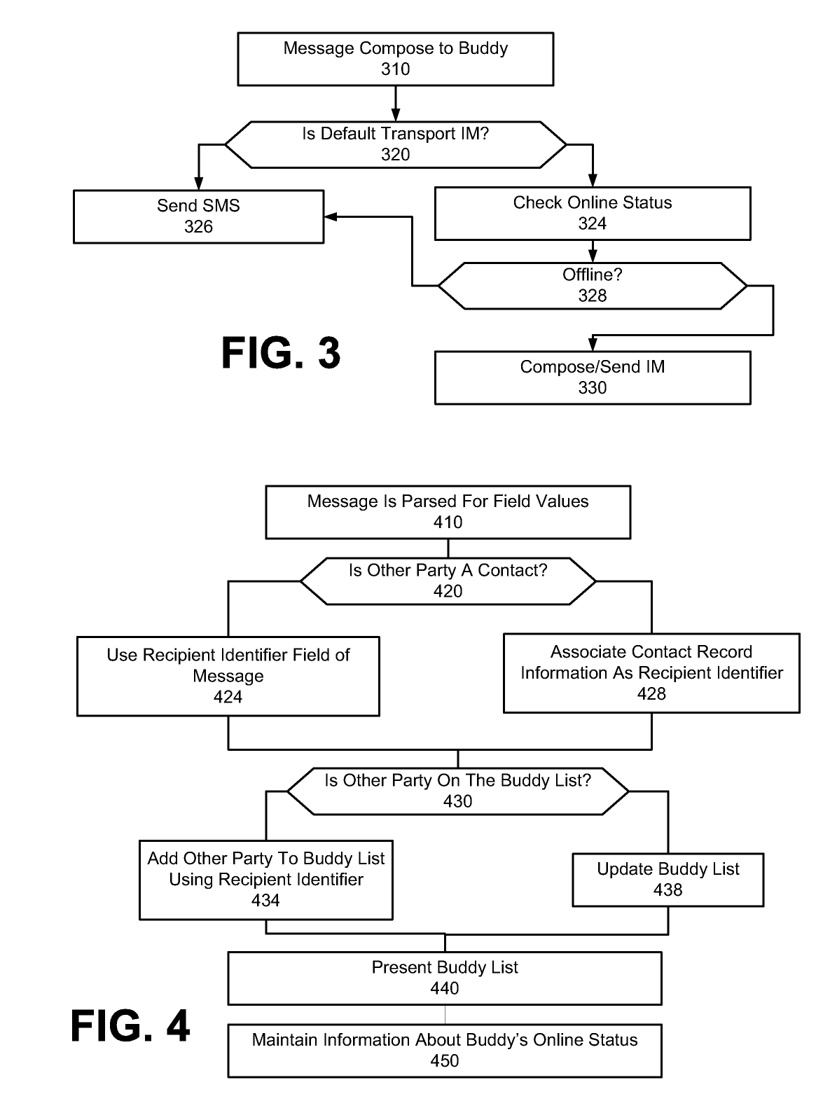

FIG. 3 illustrates a computer-implemented method for automatically selecting an appropriate messaging transport for exchanging communications with another person based on the online status of the other person, under an embodiment. Embodiments recognize that messaging transports, such as Instant Messaging, monitor the online status of their users. As mentioned with an embodiment of FIG. 1, such information may be recorded as part of the messaging information 135 (Instant Messaging information 169). In providing Instant Messaging transport, one or more embodiments recognize that the computing device 100 may receive and display the online status of individuals that the user may communicate with (e.g. through buddy-list). At the same time, the online status of a person may be used to select a messaging transport for the individual.

FIG. 3 may be implemented in reference to the buddy list 118, which is a list of contacts or identifiers from which the user of the computing device 100 may select to communicate with.

With reference to FIG. 3, step 310 provides that the user of computing device 100 composes, or initiates composition of a message to a buddy. A buddy may correspond to an individual represented by contact information or transport identifier in the buddy list. In general, a buddy list comprises contacts (or identifiers) of individuals that (i) the user designates as a buddy for the list; (ii) have most recently been messaged; and/or (iii) are most commonly messaged. In the context of an embodiment such as described, the buddy list 118 may mirror or be shared in part with other buddy lists of other messaging applications. For example, the buddy list 118 may include at least some entries that comprise a buddy list that the user has for an Instant Messaging application. In one implementation, the buddy list 118 on the computing device may be formulated in part by the buddy list as communicated from one or more of the Instant Messaging applications or services that the user operates from the computing device.

As an alternative or addition, an embodiment such as described with FIG. 3 may be implemented in a form that extends to user-interface features or usages other than those that include a buddy list. For example, one or more embodiments may be implemented on other messaging lists (e.g. last ten persons to receive a message from the computing device), or for persons with contact records that include identifiers for use with Instant messaging services.

Table 2 is a simplified representation of a database table from which a buddy list may be generated and displayed. An example of a rendered buddy list table is displayed with FIG. 5xx.

TABLE 2
Simplified tabular representation of buddy list with online status

| Contact | | Online | | Online |
|---|---|---|---|---|
| Identifier | Moniker | Status | Moniker | Status |
| Joe | JSMITH@gtalk | Off | Crazykidz2@aol | On |
| Smith | | | | |
| John Doe | | | Jdoe999@yahoo | On |

In one embodiment, database 140 includes a separate table for maintaining information for use with buddy list 118. For at least some entries on the buddy list 118, the online status information for the represented individuals Instant Messaging account may be recorded in the database on an ongoing basis by the corresponding IM service. The IM service may repeatedly or continuously communicate the status information of the buddies across an Internet connection to the device 100 (e.g. using cellular data line or WiFi connection when device is mobile computer). Thus, for example, in the third column, the status of the first user (“Joe Smith) may be switched from off to on, as needed, based on communications received from the IM service (e.g. GTALK). As described with FIG. 1, for example, IM application 126 may open and maintain a connection with the Instant Messaging service 127 using information pushed or otherwise provided by the corresponding Instant Messaging service, over the open connection with the computing device 100. In an embodiment, such online information is stored in the database 122 and associated with the contact or IM moniker of persons that are on the buddy list (or other lists in other context).

In response to the user of computing device 100 initiating or composing a message, step 315 provides that a determination is made as to whether the default transport for the intended recipient is Instant Messaging. The default transport may be set globally (e.g. for all users, unless specified otherwise), or responsively to certain conditions or events. For example, in the latter case, the default transport may be set by the mode of transport selected for the most recent past communication to the intended recipient. Thus, for example, if the user had previously sent an IM to the intended recipient of the newly composed message, the default messaging transport would be the IM transport, and optionally, the same IM Service (if more than one is possible). If the determination is that default transport is not Instant Messaging, then step 320 provides that in step 325, that other messaging transport is used (e.g. SMS or MMS). Otherwise, if the determination is that the default transport is Instant Messaging, then step 324 provides that the status of the person identified by the buddy-list entry is determined.

In step 328, a determination is made (following determination that IM transport is to be used by default) as to whether the intended recipient of the message is online for the default IM transport. This step may be performed by, for example, the presentation component 130 checking the online status of the intended recipient through the database 140.

If the determination in step 328 is that the user is offline, an embodiment provides that the mode of transport for sending the composed message is switched from Instant Messaging to SMS. In an embodiment, the switch from IM to SMS (or other transport) occurs automatically, and even seamlessly. As a seamless switch, for example, the presentation component 130 may maintain its display of the contact information for the intended recipient, and minimize or hide the address field of the message (and thus hide the transport being used). Otherwise, the message is composed and sent using the IM transport.

In addition to switching from Instant Messaging to SMS or MMS (or vice-versa), an embodiment provides that computing device 100 automatically switches between a user's Instant Messaging service in the event the person logs off an account in use. If the user logs off one Instant Messaging account and is logged onto another, then the computing device automatically switches the transport of the user to the other Instant Messaging transport.

FIG. 4 illustrates a method for maintaining a buddy list for use in messaging with multiple transports, under an embodiment. Embodiments recognize added benefit in associating message transport identifiers (e.g. cellular phone numbers, IM monikers) to contacts when presenting buddy lists. Rather than presenting only the transport-specific messaging identifier when adding an entry to a buddy list, an embodiment provides for associating the transport identifier with a contact record, so that the buddy list displays the contact record information (e.g. person's name, picture). Moreover, one or more embodiments enable the buddy list to enable unified messaging across multiple transports, and to import entries into the buddy list using more than one transport (including Instant Messaging and SMS).

Accordingly, a method such as described with FIG. 4 may be implemented in the context of adding a person to a buddy or other list (e.g. historical list such as log or recent) in response to a messaging event: (i) receiving an incoming message, or (ii) the user sending an outgoing message. Other context for forming an entry into the buddy list are contemplated.

Steps 410-428 describe that a candidate buddy list entry may be identified in the form of (i) a contact list identifier or picture (when contact record information does exist for another party in the message exchange), or (ii) a transport-specific identifier (when no contact record information exists for another party in the message exchange). Once the candidate buddy list entry is identified, step 430 provides that a determination is made as to whether the party of the entry is on the buddy list. If the entry does not exist, then step 434 provides that the entry is added in the appropriate form (i.e. as contact identifier or as transport identifier). However, if the entry does exist, step 438 provides that the candidate buddy list entry is not added to the buddy list. The buddy list is then formulated and presented.

Sample User Interface Panels

FIG. 5A is a sample user interface panel on which a plurality of mixed transport message threads are provided as entries, under an embodiment. A user interface panel 510 may be generated from, for example, presentation component 130 (see FIG. 1). The user interface panel 510 displays a plurality of message thread entries 522, of which some may be mixed message. At the top, panel 510 includes a conversation feature 512 that is selected to display the plurality of message thread entries 522. One or more of the message thread entries 522 may be mixed (i.e. include messages from different transports). A buddies feature 514 is selectable to display a buddy list such as described with any of the embodiments (e.g. buddy list 118).

In an embodiment depicted by FIG. 5A, the conversation feature 512 is depicted as being selected. In one implementation, the message thread entries 522 are sorted by date, with the most recently updated thread being displayed on top. The message thread entries 522 may be displayed by day (e.g. ‘today’, ‘yesterday’), day of week or other timing parameter. Other sorting parameters may be implemented or used, such as by alphabet with the other party in the conversation, by buddy group, and by online status. Multiple sort parameters may also be used. For example, the sort may be by buddy group, then online status, and lastly by alphabet.

In an embodiment, each message thread entry 522 is a line entry or heading, depicting at least a portion of the body of the last message received from the other party of the thread. At least some of the message thread entries 522 show contact information 524 associated with a contact record of the other party in the exchange. The contact information 524 may correspond to the name of the other person (as listed in the contact record of the other person), or a picture associated with the contact record. In FIG. 5A, one message thread entry 522A shows a conversation with another individual that does not have a contact record associated with it. In such an implementation, the moniker of the individual may be the identifying feature of the thread entry 522A. The picture 525A may be provided by, for example, the IM Service. In contrast, the picture 525 for another one of the thread entries may be provided by the contact record store 146 (see FIG. 1).

The user may create a new message by either replying to one of the existing messages (e.g. the last message in one of the threads), or by creating a new message and inserting or otherwise composing the recipient identifier field. To compose the message, the user may select the feature 528 to open a blank message. The blank message may be opened in a default transport, which may be selected by the user or designer.

FIG. 5B is a sample user interface panel that displays a message thread in open form, according to an embodiment. A message thread 550 may be rendered by, for example, selecting one of the thread entries 522 (see FIG. 5A). When opened, multiple records of messages 562 are displayed in an integrated form (e.g. such as by list). The message thread 550 may be considered to be a mixed transport thread if it includes records from different messaging transports. As mentioned, a messaging transport may differ by the program it uses, the format of its messages, and the protocol implemented to communicate the message. Different messaging transports typically communicate using different off-device or network resources. In one embodiment, at least one of the message records 562 in the mixed transport thread 550 is recorded through use of an Instant Messaging transport. Another message record 562 may be recorded through use of another messaging transport, such as SMS or MMS.

In an embodiment, variations of transport in the message records 562 are made substantially transparent to the user. Specifically, each message in the thread may be presented as a record, regardless as to whether it was received or sent through Instant Messaging, SMS, or MMS. The user may create a new message for the thread by replying to an existing message, or composing a new message. A default transport may be assigned for any outgoing message composed on the device. The default transport may, for example, be rule-based and automatically determined, as described with, for example, an embodiment of FIG. 3. In such an embodiment, the transport mode that is selected is (i) Instant Messaging, if the receiver's online status indicates that the individual is online; (ii) if the user is offline, SMS or MMS. As a variation or alternative, the default transport may correspond to the transport that was most recently used, or used in the message from which a reply message is newly created on the computing device.

In a variation, the user of the computing device may generate a reply message that has a different messaging transport than the message that served as the basis of the reply. In the example of the messaging thread 550, the first message in the thread may be composed by the user of the computing device. The user may select the message transport, or one may be selected programmatically (e.g. through default). In the example provided, two reply messages are received. The first of the reply messages may be assumed to be in the transport of the original message. The second message, however, may not be a true reply to the original message, but a message composed on the recipient's device that is communicated on that other device outside of the thread. Nevertheless, when it is received on the computing device, it is automatically associated with the thread. In such an example, (i) the original message may be communicated using an Instant Messaging transport, (ii) the first reply message may be from the recipient as an Instant Message, so as to be a true-reply that is reflected as such by the action of the recipient; (iii) the second message from the recipient may actually be an SMS or MMS from the recipient's cellular phone. The second reply may be associated with the thread 550 when it is received by the SMS program 122, then parsed by the database logic 142 and stored in parsed form. If the recipient has a contact record associated on the computing device, the incoming SMS message may be associated with a contact record, which in turn is associated with an existing messaging thread. The incoming SMS message may then be associated with the existing thread 550 (FIG. 5A), which originated using Instant Messaging. In an embodiment, the association of the incoming SMS message to the existing thread having Instant Messages is automatic. Moreover, variations are possible. For example, the original message from the user of the computing device may be sent using SMS, replied to in SMS, then followed up with another Instant Message (as the second reply message).

According to one or more embodiments, when the user of the computing device receives the second message, he or she may reply and have the messaging transport for the reply automatically selected. In one embodiment, the reply message from the user (“I have some errands . . . ”) is selected to have the same transport as the incoming message (“What are you doing . . . ”) that is being replied to. Such a transport selection may be made automatically, by default. As an alternative or addition, another transport may be selected for the reply message by the user. Specifically, the user may reply and manually select another transport for the reply message (e.g. Instant Messaging). As a reply message, the contents of the previous message may or may not be carried into the newly created reply message, depending on the implementation. As a variation, the user may reply and the computing device may automatically and programmatically select a different transport for the reply message. Such a programmatic selection may be made by rule. For example, in response to the incoming SMS message (“what are you doing tonight . . . ”), a rule may state that the reply must be the same transport (e.g. SMS) unless the user's online status for the Instant Messaging transport is active, in which case the reply message is to be carried out with Instant Messaging. As previously stated, the contents of the previous message may or may not be carried into the newly created reply message, depending on the implementation.

In an embodiment of FIG. 5B, each person in the ‘conversation’ has an image associated. The image may be derived from the contact record information. Alternatively, the image may be received as part of the Instant Messaging transport. Even in the latter case, the image may be carried through the entire messaging thread.

FIG. 5C is a sample user interface panel that illustrates a mixed transport thread 570 that includes messages 572 exchanged using three messaging transports, according to an embodiment. A first message 572 in the thread 570 may be generated from another source, so as to be incoming to the computing device. The user of the computing device may reply, as described with any of the embodiments of, for example, FIG. 5B. As an example, the originating message (“What are you doing . . . ”) may be sent through the Instant Messaging transport, and the reply message may be sent through the same transport (by rule, default or manual selection). A second message 574 from the recipient may be an MMS message (carrying a media object 575). It may be presented with media object 575 in rendered form as part of the thread 570. The association may be made to the thread even though the message was composed outside of the thread (e.g. on the other participant's mobile device, apart from the source of the Instant Messaging transport) and off-topic to the thread.

FIG. 5D is a sample user interface panel that displays a buddy list that may be used on a messaging system such as described by any of the embodiments provided herein. In an embodiment, a buddy list 580 lists entries, corresponding to persons and their messaging transport identifiers. With reference to an embodiment of FIG. 1, for example, the buddy list 580 is made available as part of an output that can be generated from the user interface 134. In this way, the buddy list 580 may be generated through use of the database 140, as well as other data resources such as the contact database. The buddy list 580 may thus be provided as a feature that incorporates and integrates functionality across multiple messaging transports.

In FIG. 5D, the buddy list 580 may comprise of entries 582, of which each identifies a person with whom the user of the computing device can exchange messages with. The identification of the person in the entry 582 may be made by way of either (i) the Instant Messaging service or services from which the buddy list entries are identified, or (ii) contact information (from the contact database), and include name or other information.

According to one or more embodiments, the buddy list 580 is formulated at least in part from one or more Instant Messaging transports. For example, a buddy list provided from the Instant Messaging service 127 may be stored in the database and used to provide some or all of the entries 582. If the user has two Instant Messaging services 127, two buddy lists may be combined. As an alternative or addition, the buddy lists may be specified by the user through use of the interface 578 and/or through activity performed on the computing device in connection with any of the transports (such as SMS or MMS or email). Thus, in one embodiment, at least some of the entries 582 in the buddy list 580 are derived from sources outside of the Instant Messaging service 127 (FIG. 1).

In an embodiment, one or more entries in the buddy list 580 derive from the Instant Messaging service 127, but the entries are associated with contacts rather than monikers or other listing format of the service. For example, the entries of the Instant Messaging service are compared against the contact records on the computing device, so as to identify contact records in place of monikers or other identification data from the Instant Messaging service. The entry of Instant Messaging service 127 may be supplemented or swapped with the contact record entry, which enables the entry to be associated with (i) the name of the person of the entry, as recorded in the contact record, (ii) picture or other identifier, (iii) shortcut access to other transport identifiers of the contact record. In one embodiment, the user may be able to act on the entry 582 when it is presented or associated with other information and identifiers of the contact record. For example, the user may be enabled to call the contact (using a mobile device as the computing device) or email the contact (using an email program) by initiating a programmatic action or trigger that is incorporated or made available with presentation of the entry 582. Such actions may provide an alternative to uses of the buddy list 580, other than just sending SMS/MMS/IM message.

As described above, one or more embodiments also enable the presentation component 130 (FIG. 1) to generate the buddy list 580 without creating duplicate entries 582 as a result of user actions or merging of buddy lists. In particular, the database 140 may be uses to filter instances when two candidate entries of a buddy list are deemed to be the same contact or person (via comparison with the contact records database, as described above). Thus, if a candidate entry for a buddy list is identified from a first source (e.g. first Instant Messaging Service using a first moniker), and then identified from a second source (e.g. second Instant Messaging Service using a second moniker; incoming SMS message etc.), but the candidate entries are both the same person, then the duplicate entries are represented as one entry that identifies the contact record. The filtering of the buddy list 580 in this manner may be implemented by, for example, the database logic 142 (FIG. 1) and/or presentation component 130 (FIG. 1).

As another feature, the buddy list 580 can be updated through one or more Instant Messaging Services that pertain to the buddy list. For example, buddies that are offline (for receiving IMs) can be grayed out (see first entry). Display greetings 581 may also be carried onto the buddy list by the Instant Messaging service 127 (FIG. 1). Thus, for example, the presentation component 130 (FIG. 1) uses the message database 140 to augment or enhance the display of the buddy list 580.

As described above, a buddy list can be updated without including (i) duplicate entries of identical transport identifiers, (ii) double listing of contacts, or (iii) inclusion of two or more messaging transport identifiers to the same contact. More specifically, the candidate buddy list entry is for a contact that is already on the buddy list via another transport identifier, the contact is not listed twice on the buddy list. Thus, duplicate listing of contacts who have more than one transport identifiers is also avoided.

Hardware Diagram

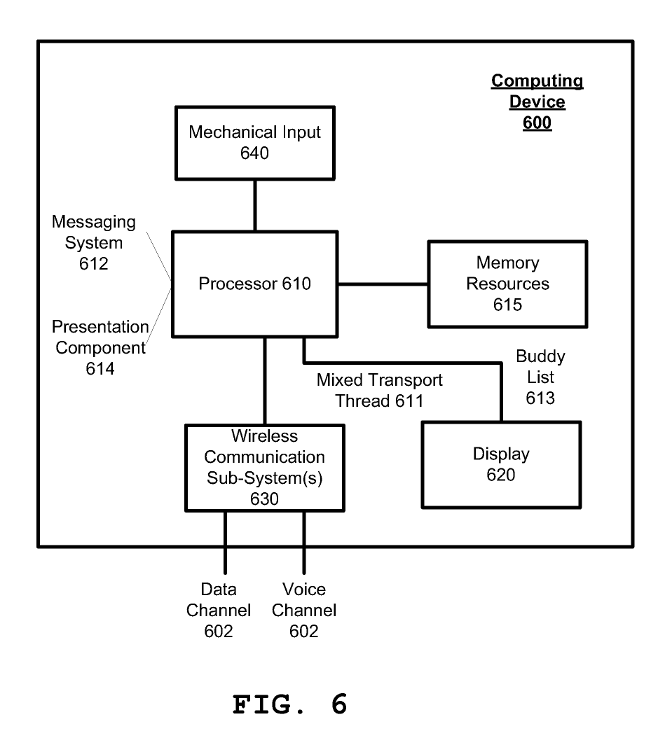

FIG. 6 illustrates a hardware diagram for a computing device that is configured to implement one or more embodiments described herein. A computing device 600 may correspond to a mobile computing device, such as a cellular device that is capable of telephony, messaging, and data services. Examples of such devices include so-called smart phones or handsets for cellular carriers. Accordingly, in one embodiment, device 600 includes a processor 610, memory resources 615, a display 620, one or more wireless communication sub-systems 630, and mechanical input features 640. In an embodiment, at least one of the wireless communication sub-system 630 sends and receive cellular data over data channels 602 and voice channels 604. Messages over SMS and MMS transports are communicated over voice channels 604. Emails and instant messages are communicated over data channels 602. Typically, email and instant messaging may be communicated by either a cellular medium or an alternative medium (e.g. WiFi, WiMAX, wireline), but this does not necessarily need to be the case. To accommodate more than one transport medium, the device 700 may include more than one wireless subsystem.

The processor 610 is configured with software and/or other logic to perform one or more processes, steps and other functions described with embodiments such as described by FIG. 2 through FIG. 4, and elsewhere in the application. Processor 610 is configured, with instructions and data stored in memory resources 615, to implement the messaging system 612 (as described with FIG. 1). A database of the messaging system may record messaging events that are threaded and have mixed transports. Still further, the processor 610 may implement a presentation component 616 that causes the display of mixed transport threads 611, buddy lists 613 and other features, such as described by any of the embodiments provided herein. The incoming and outgoing messages may be received or transmitted from the wireless sub-system (which may or may not include processor 610).

While FIG. 6 is illustrated for a mobile computing device, one or more embodiments may be implemented on other types of devices, including multi-functional devices (e.g. camera or GPS enabled devices that have messaging enabled on different transports), or full-functional computers such as laptops.

### Alternative Embodiments

While numerous embodiments described herein provide for a mixed message transport thread that is comprised of Instant Messaging, SMS and/or MMS, other embodiments may provide or use other forms of messaging transports in a mixed messaging thread. As an alternative or addition, for example, a mixed transport messaging thread may include or support email messages.

A mixed transport messaging thread such as described by any of the embodiments may be extended to threads for groups. In one implementation, a group is defined as the set of individuals or identifiers that are specified in a message that is sent to multiple users. For example, an SMS message may have three recipients: Joe, Tom and Bill. A first message from Joe to the other members of the group may be followed by a reply to all by one of the recipients. Any of the members of the group may use a computing device such as described to maintain the messages exchanged amongst the group in a thread. Thus, the original and each reply all message exchanged amongst the group may be displayed in a common thread. Moreover, newly composed messages by one member of the group to the other members of the group may also be associated with the thread. In this context, an embodiment provides that individual messages exchanged amongst the group are identified as being part of the common group thread, even though the messages are exchanged using different messaging transports, and/or are newly composed (rather than reply messages).

With further reference to FIG. 1, one or more embodiments may further extend information in the messaging database to other device resources that can utilize information from the messaging database. For example, as mentioned, the database 140 may communicate, or provide access to, the online status information of individual contacts or persons to, for example, the contacts data store. In this way, the online status information of individuals may serve as a form of presence information. For example, when the user scrolls through the contact data store on the device, the online status information of individuals that have Instant Messaging identifiers recorded may be displayed. Such information may indicate to a user of the computing device that a particular contact is, for example, in front of a computer (so as to answer the phone), or able to receive Instant Messages.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A computing device comprising:
processing resources that operate to provide a plurality of messaging programs, wherein each messaging program is operable to send an incoming message or transmit an outgoing message using a format and protocol that is different from the other of the programs;
a messaging database that interfaces with the plurality of messaging programs to record instances of incoming or outgoing messages using anyone of the plurality of messaging programs;
wherein the processing resources execute in connection with maintaining the messaging database in order to:
associate individual incoming messages or outgoing messages with either a new messaging thread or an existing messaging thread, the incoming messages and outgoing messages of each new or existing messaging thread being received or sent through any one of the plurality of messaging programs; and
display each new and existing messaging thread.

2. The computing device of claim 1, wherein the messaging database records instances of messages that are sent from or received on the computing device using two or more wireless communication ports, and wherein the processing resources provide two messages that are communicated using the two or more wireless communication ports in a single messaging thread.

3. The computing device of claim 1, wherein the computing device includes a cellular communication port, and wherein the plurality of messaging programs include a first program that is configured to use a voice channel of the communication port, and a second program that is configured to use a data channel of the communication port, and wherein the processing resources are configured to enable a given messaging thread to include one or more messages of each of the first program and second program.

4. The computing device of claim 1, wherein at least one of the messaging programs is an Instant Messaging program.

5. The computing device of claim 3, wherein at least another of the plurality of messaging programs is either a Short Messaging Service (SMS) or Multimedia Messaging Service (MMS) program.

6. The computing device of claim 1, wherein the processing resource include logic associated with the database that parses individual incoming or outgoing messages to determine information to associate that message with either (i) a contact record from a contact data store of the computing device, or (i) one of the existing messaging threads.

7. The computing device of claim 6, wherein the processing resources parse the individual incoming or outgoing message to determine information corresponding to a messaging identifier of another party that sent or received the message, then compares the messaging identifier to information contained in individual contact records of the contact data store in order to associate a particular contact record with that message.

8. The computing device of claim 1, wherein the processing resources associate the incoming or outgoing message with the existing thread by determining that the existing thread is associated with the contact record.

9. The computing device of claim 1,
wherein the processing resources execute to assign a default messaging program for initiating messages to other participants;
wherein the messaging database records information provided from a service that is used by the default messaging program, the information including online status information;
wherein the processing resource execute to use an alternative messaging program if the online status information indicates that the other participant is not online.

10. The computing device of claim 1, wherein the processing resources execute to display new and existing messaging threads by enabling a user of the computing device to reply to an incoming message of one of the existing messaging threads using a different messaging program that was used to receive the incoming message on the computing device.

11. The computing device of claim 10, wherein the incoming message is either an Instant Messaging or cellular service message, and a reply message to the incoming message is the other of the Instant Messaging or cellular service message.

12. The computing device of claim 1, wherein the processing resources execute to display new and existing messaging threads by identifying two or more messages sent from another recipient using different messaging programs as belonging to one messaging threads.

13. A computing device comprising:
a plurality of communication ports for communicating data to and from the computing device, including at least a first communication port and a second communication port;
a combination of processing and memory resources that are operable to implement a messaging system on the computing device, wherein the messaging system is configured to maintain and present a mixed transport chat thread between a user of the computing device and another individual, the mixed transport chat thread comprising multiple records of messages that are exchanged between the user and the other individual, including records of individual messages communicated to the other individual using each of (i) a first messaging transport that is communicated with the first communication port, and (ii) a second messaging transport that is communicated with the second communication port.

14. The computing device of claim 13, wherein the plurality of communication ports includes a first wireless communication port for enabling the computing device to connect to a local area or enterprise network, and a second communication port for enabling the computing device to send and receive cellular communications.

15. The computing device of claim 13, wherein the first messaging transport is for sending messages in one of Short Message Service (SMS) or Multimedia Message Service (MMS), and the second messaging transport is for sending and receiving messages of an Instant Messaging service.

16. The computing device of claim 15, wherein the first messaging transport uses a cellular communication port and the second messaging transport uses a wireless local area network port.

17. The computing device of claim 13, wherein the messaging system includes:
a database;
a plurality of messaging applications, including a messaging application for each of the first messaging transport and the second messaging transport, the plurality of messaging applications being coupled to have access to the database;
wherein each of the plurality of messaging applications is operable to record instances of receiving or transmitting individual messages through operation of that messaging application.

18. The computing device of claim 17, wherein the database maintains a plurality of records, and each record maintains information corresponding to an instance of a received or transmitted message, and wherein the user interface layer is configured to generate one or more mixed transport messaging threads using records that are maintained by the database.

19. The computing device of claim 17, wherein the plurality of messaging applications includes a Short Service Messaging (SMS) application, a Multimedia Messaging Service (MMS) application, and an instant messaging application.

20. The computing device of claim 13, further comprising a contact data store that is accessible as part of or for use with the messaging store, wherein the contact data store includes a plurality of contact records for persons that are identified by the user, and wherein the user interface identifies information from a contact record of the other person identified in the mixed transport messaging thread and displays that information as part of the messaging thread.

19. The computing system of claim 18, wherein the information that is displayed as part of the representation of the messaging thread is a name of the other person as identified in the contact record.

20. The computing system of claim 18, wherein the information that is displayed as part of the representation of the messaging thread is an image of the other person as associated or stored with the contact record.
